(19) United States
(12) Patent Application Publication
(10) Pub. No.: US 2006/0253590 A1
(43) Pub. Date: Nov. 9, 2006

(54) Platform and methods for continuous asset location tracking and monitoring in intermittently connected environments

(75) Inventors: David Nagy, San Jose, CA (US); Wesley Cheng, Palo Alto, CA (US)

Correspondence Address: TRAN & ASSOCIATES, 6768 MEADOW VISTA CT., SAN JOSE, CA, 95135, US

(73) Assignee: KONAWARE, INC.

(21) Appl. No.: 11/399,549

(22) Filed: Apr. 5, 2006

Related U.S. Application Data
(60) Provisional application No. 60/669,763, filed on Apr. 8, 2005.
(60) Provisional application No. 60/671,284, filed on Apr. 13, 2005.

(51) Int. Cl. G06F 15/173

(52) U.S. Cl. 709/226

(57) ABSTRACT

Systems and methods are disclosed to track first and second nodes equipped with radio frequency identification (RFID) tag readers by registering a first node and a second node with a registration server; assigning the first and second nodes to first and second home servers respectively, wherein the first node is authorized to communicate with the first home server and the second node is authorized to communicate with the second home server; and for each query requested by each node, sending the query to the registration server to be broadcasted to the home servers.

This application claims priority to Provisional Application Ser. No. 60/669,763 filed Apr. 8, 2005 and Provisional Application Ser. No. 60/671,284 filed Apr. 13, 2005, the contents of which are incorporated by reference.

The present invention relates generally to radio frequency identification (RFID) systems.

In recent years, radio frequency identification (RFID) systems have been employed in an ever increasing range of applications. For example, RFID systems have been used in supply chain management applications to identify and track merchandise throughout manufacture, warehouse storage, transportation, distribution, and retail sale. RFID systems have also been used in security applications to identify and track personnel for controlling access to restricted areas of buildings and plant facilities, thereby prohibiting access to such areas by individuals without the required authorization. Accordingly, RFID systems have been increasingly employed in diverse applications to facilitate the identification and tracking of merchandise, personnel, and other items and/or individuals that need to be reliably monitored and/or controlled within a particular environment.

A conventional RFID system typically includes at least one RFID transponder or tag, at least one RFID reader, and at least one controller or host computer. For example, in a manufacturing environment, RFID tags can be attached to selected items of manufacture or equipment, and at least one RFID reader can be deployed in the environment to interrogate the tags as the tagged items pass predefined points on the manufacturing floor. In a typical mode of operation, the reader transmits a radio frequency (RF) signal in the direction of a tag, which responds to the transmitted RF signal with another RF signal containing information identifying the item to which the tag is attached, and possibly other data acquired during the manufacture of the item. The tag may also include at least one integrated transducer or environmental sensor for providing data such as the temperature or humidity level of the ambient environment. The reader receives the information and data transmitted by the tag, and provides the tag data to the host computer for subsequent processing. In this typical operating mode, the reader can be configured as a peripheral connected to a serial port of the host computer.

More recently, RFID readers have been developed that are capable of being connected via a communications network to enterprise computer resources running one or more RFID-enabled client software applications. Such readers have been deployed in complex systems including many readers (e.g., greater than 10) connected via one or more communications networks to a number of host computers, which may be part of an enterprise network server. Such host computers can run client applications for processing tag data to control access to building and plant facilities, the movement of personnel and property, the operation of lighting/heating/ventilation/—air conditioning facilities, and/or other diverse functions.

Whether implemented as computer peripherals or networked devices, conventional RFID readers generally collect data from RFID tags much like optical barcode readers collect data from barcode labels. However, whereas an optical barcode reader typically requires a direct line of sight to a barcode label to read the data imprinted on the label, the RF signals employed by the typical RFID reader can penetrate through and/or diffract around objects obstructing an RFID tag from the RF field of view of the reader, thereby allowing the reader to access data from a tag that, for example, might be buried beneath one or more boxes of merchandise. In addition, unlike the optical barcode reader, the conventional RFID reader can operate on and distinguish between multiple RFID tags within the field of the reader.

In the conventional RFID system, each RFID tag typically includes a small antenna operatively connected to a microchip. For example, in the UHF band, the tag antenna can be just several inches long and can be implemented with conductive ink or etched in thin metal foil on a substrate of the microchip. Further, each tag can be an active tag powered by a durable power source such as an internal battery, or a passive tag powered by inductive coupling, receiving induced power from RF signals transmitted by an RFID reader. For example, an RFID reader may transmit a continuous unmodulated RF signal (i.e., a continuous wave, CW) or carrier signal for a predetermined minimum period of time to power a passive tag. The volume of space within which a reader can deliver adequate power to a passive tag is known as the power coupling zone of the reader. The internal battery of active tags may be employed to power integrated environmental sensors, and to maintain data and state information dynamically in an embedded memory of the tag. Because passive tags do not have a durable power source, they do not include active semiconductor circuitry and must therefore maintain data and state information statically within its embedded memory. In addition, passive tags have an essentially unlimited life span, while the life span of active tags is typically limited by the lifetime of the internal battery, which in some implementations may be replaceable.

### BRIEF DESCRIPTION OF THE DRAWINGS

FIG. 1 is a block diagram illustrating the components of an exemplary Mobile RFID system.

FIG. 2 shows an exemplary Mobile RFID System with Nodes communicating over a Wireless Network.

FIG. 3 shows an exemplary block diagram depicting functional components resident on one or more mobile computers.

FIG. 4 shows an exemplary block diagram depicting functional components resident on one or more server computers.

FIG. 5 shows an exemplary flow diagram depicting the process of loading assets into a vehicle or container.

FIG. 6 shows an exemplary flow diagram depicting the automatic process of tracking and monitoring assets in the Mobile RFID System.

FIG. 7 shows an exemplary flow diagram depicting the process of executing and responding to a query from an Enterprise System.

FIG. 8 shows symbols used to indicate the components of the system in FIGS. 9-20.

FIG. 9 shows examples of Static and Terminal Nodes.

FIG. 10 shows examples of Mobile Nodes.

FIG. 11 shows an exemplary process for Node Registration.

FIG. 12 shows an exemplary process to perform Node to Server Assignment.

FIG. 13 shows an exemplary process for Item Creation.

FIG. 14 shows an exemplary process for performing Item Transfer from Static/Terminal to Mobile Node.

FIG. 15 shows an exemplary process for performing Item Transfer from Mobile to Static/Terminal Node.

FIG. 16 shows an exemplary process for performing Item Record Transfer.

FIG. 17 shows an exemplary process for performing Item Query to Static Node.

FIG. 18 shows an exemplary process for performing Item Query to Mobile Node.

FIG. 19 shows an exemplary process for performing Unauthorized Item Query.

FIG. 20 shows an exemplary process for performing Item Consumption.

### SUMMARY

In one aspect, systems and methods are disclosed to track first and second nodes equipped with radio frequency identification (RFID) tag readers by registering a first node and a second node with a registration server; assigning the first and second nodes to first and second home servers respectively, wherein the first node is authorized to communicate with the first home server and the second node is authorized to communicate with the second home server; and for each query requested by each node, sending the query to the registration server to be broadcasted to the home servers.

In a second aspect, a system to track first and second wireless nodes includes a network; first and second home servers coupled to the network and communicating with the first and second wireless nodes, respectively, wherein the first node is authorized to communicate with the first home server and the second node is authorized to communicate with the second home server; a registration server coupled to the network and adapted to assign the first node to the first home server and the second node to the second home server; and an enterprise computer coupled to the network to query the nodes.

Implementations of the above two aspects may include one or more of the following. The system allows data to be communicated between the first and second nodes by sending data from the first node to the first home server, sending data from the first to the second home server, and sending data from the second home server to the second node. The system authenticates each node. The authenticating can include submitting an identification and a password. The nodes can include a static node, a terminal node, or a mobile node. The system communicates node data over multiple, disparate, and intermittently connected wireless networks. The system can determine a physical location or an environmental status of a node. The system can include monitoring of assets such as a vehicle, a container, an equipment, or inventory. The system performs a bi-directional transmission of requests from, and replies to, applications containing commands, and status and location data. The system can performs authorization forward chaining. The system can communicate only node location and date information to preserve privacy, or the system can communicate identity of the asset as well.

In another aspect, a system is disclosed for tracking and monitoring the location and/or status of assets that are in transit, including attributes of their surrounding environment. To track an asset in the context of the present invention is to verify its past, present, and projected future locations anywhere on the planet. To monitor an asset is to verify its status relative to a known location or locations, such as a defined geographic boundary. For the purposes of this description, status may refer to the presence of absence of an asset, state of an asset (e.g., on, off), or attributes or environment in which the asset resides (e.g., temperature, pressure, moisture, speed, direction, radiation, chemicals). An asset may be an item, group of items (hierarchy), container (box, palette, etc.), vehicle (truck, rail car, etc.), or equipment (tools, machines, etc.).

In yet another aspect, a system provides automatic tracking and monitoring of assets regardless of location and without continuous wireless network coverage. The system elements described herein include, but are not limited to, a Web Service for programmatic access to the system, a system manager function for single point of access to myriad interconnected fixed and mobile RFID nodes, a multi-channel wireless platform for guaranteed communications, a plurality of mobile computing devices, a plurality of fixed mobile or handheld mobile RFID transceivers, and a plurality of assets equipped with RFID tags and/or environmental sensors.

In one embodiment, the system provides an asset tracking and monitoring system having: a) an RFID reader equipped with local area wireless communications (e.g., BlueTooth or WiFi) in a fixed position inside a vehicle or shipping container; and b) a mobile or fixed handheld computer equipped with local area and wide area wireless communications software and hardware; a plurality of assets equipped with RFID tags capable of EPC data storage and/or environmental sensing (e.g., temperature, humidity, CO2); d) a server computer with connections to wireless networks; and e) server software and hardware that manages the flow of data between mobile assets and backend enterprise systems.

Another embodiment of the present invention provides an asset loading/unloading system. The system is composed of: a) an RFID reader equipped with local area wireless communications (e.g., Bluetooth or WiFi) in a fixed position near the doors of a vehicle, shipping container, or loading dock; and b) a mobile or fixed handheld computer equipped with local area and wide area wireless communications software and hardware; a plurality of assets equipped with RFID tags capable of EPC data storage and/or environmental sensing (e.g., temperature, humidity, CO2); d) a server computer with connections to wireless networks; and e) server software and hardware that manages the flow of data between mobile assets and backend enterprise systems.

Advantages of the system may include one or more of the following. The system reduces or eliminates problems associated with lack of visibility into supply chains such as inefficient production planning, poor customer service, and lost, misplaced, and misdirected items. It also reduces the substantial cost of locating assets across multiple modes of transportation, intermediate storage, and permanent storage. The system provides methods, procedures, and enhancements that yield the maximum amount of detail and accuracy, and reliability on asset location and status. The system supports identifying and tracking tagged merchandise, personnel, and other items and/or individuals within an RFID environment with increased reliability.

### DESCRIPTION

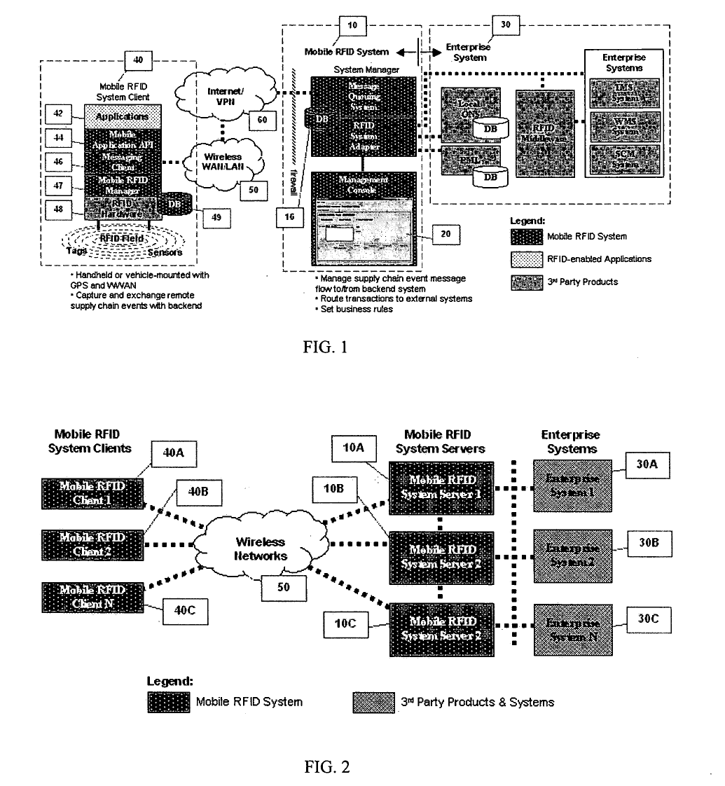

FIG. 1 shows a block diagram of an exemplary mobile radio frequency identification (RFID) system illustrating the components and relationship of the present invention to each other, and to external hardware and software system that may be supplied by third parties, among others.

The system has a System Manager 10 which communicates with one or more enterprise systems 30. The System Manager 10 includes a Message Queuing System 12 that provides messaging/transactional services to enable Enterprise Systems and Mobile Systems to be connected over any type of wireless network. It also guarantees message delivery on a once-and-only-once basis and contains persistent data storage in the event the Mobile becomes disconnected from the Mobile System. The Wireless Platform includes both servers-based components and mobile device-based components. The System Manager 10 also includes an RFID System Adapter 14 that serves at the point of integration between the Mobile RFID System and Enterprise Systems 30. The Manager Queuing System 12 and the RFID System Adapter 14 store information in a database 16.

In one embodiment, the System Manager 10 is server-based system software that runs on a variety of industry server platforms. It stores and executes business rule as defined by system administrators through a Management Console 20. In one embodiment, the Management Console is Browser-based application software that enables system administrators to enter and update a variety of parameters that the System Manager 10 uses to control the Mobile RFID System. The Management Console 20 includes Business Rules that allows a system administrator to enter business rules through a series of screens to be executed by the System Manager 10. The Management Console 20 also allows a system administrator to enter automated asset reporting parameters to be executed by the System Manager. The Console 20 also allows a system administrator to enter automated alert parameters to be executed by the System Manager. The Console 20 also allows the enterprise systems 30 to query the status of assets.

In another embodiment, a Web Service provides a primary interface to the Mobile RFID System. The Web Service allows Enterprise Systems 30 to send commands and requests and in return receive status information back. It allows Enterprise Applications to set configurations of alerts conditions, reporting rules, and to query the status of specific assets and environments. Configuration settings are stored in Configuration Tables. Examples of operations done through the Web Service include:
1. Send an alert to the Enterprise System if asset(s) are removed from the RFID Field
2. Send an alert to the Enterprise System if asset(s) are removed from the RFID Field while the RFID Field is outside a particular geographic region (as defined by a geo-fence, which may be a GPS location and a specified radius around that location).
3. Send and alert to the Enterprise System if the average temperature of the environment in which the asset is contained exceed X degrees.
4. Automatically report the location of the asset(s) every X hours.
5. Immediately report the location of the asset(s).

A Mobile RFID System Client 40 is a system running on a variety of industry standard handheld device platforms. An application 42 runs on the Mobile RFID System Client 40 to support inventory or asset management applications, for example. The application communicates with a Mobile Application API 44 which supports a range of functions including, but not limited to:
1. Scan EPC tags in the immediate RFID field and return EPC code data;
2. Scan sensor tags in the immediate RFID field and return requested data according to sensor type, e.g., current temperature inside a container, temperatures recording over a specific period, or maximum and minimum temperatures that the container has been subjected to.
3. Write EPC data to a tag.
4. Set parameters in the Mobile RFID Manager to trigger alerts based on pre-set conditions occurring in the RFID Field.

The Client 40 works in conjunction with a Messaging Client 46 to provide applications with programmatic access to local onboard or local area wireless RFID devices, and to remote servers and enterprise systems over a variety of wireless network types. An RFID Manager 47 serves as the central access point in the Mobile Device to provide asset visibility and monitoring services to applications through the API 44, uses connection services provided by the Wireless Platform to communicate with Enterprise Systems 30, and an interface to the RFID Manager 47. A module accessible through the Mobile RFID Manager 47 monitors and controls read and write functions in an attached RFID Field. Action may be driven by local Mobile Applications 42, remote Enterprise Systems 30, or settings in Configuration Tables.

A Message Client 46 runs on the mobile/handheld device to provide messaging and or transactional communications over any type of wireless network to the Message Queuing System 12. It provides message delivery on a once-and-only-once basis and contains persistent data storage in the event the Mobile becomes disconnected from the server side of the Message Queuing System 12. The Messaging Client 46 communicates with a wireless WAN or LAN 50, which in turn communicates over the Internet 60 with the Mobile RFID System 10. The communication can occur over a virtual private network (VPN) and a firewall to provide secure communication.

The RFID hardware 48 communicates with RF tags or sensors. The RF tag receives signals from and transmits signals to RFID/RFDC hardware 48 over a communications path. The RF tag is preferably passive but may be active, if desired. When the RF tag receives an interrogation signal, the RF tag may or may not send a response signal. RFID hardware 48 may be able to interrogate an individual, some, or all RF tags or sensors. The RF tags or sensors may contain memory such as read only memory (ROM), random access memory (RAM), flash memory, Erasable Programmable Read Only Memory (EEPROM), or the like which stores information. For example, the RF tag may contain a preamble message code that may contain a code specific to RF tags, and/or the asset or location associated with RF tags. The RFID hardware 48 may be able to address specific RF tags by using codes in the interrogation signal. RFID hardware 48 may also be able to modify the content of the memory of a specific RF tag. Such memory modification may be particularly useful when a particular RF tag is initially associated with an asset. This may be done, for example, by allowing an asset code to be entered and stored in the RF tag. The RF tags or sensors may also be individually addressable based on the frequency of the interrogation signal or by any other suitable method (e.g., unique addresses). Alternatively, RF tags or sensor may send response signals that are specific to a particular RF tag, sensor and/or the asset or location associated with the RF tag or sensor. The response signals from separate RF tags or sensors may be distinguishable by their frequency, a time delay, unique identifier, or by any other suitable method.

FIG. 2 shows an exemplary Mobile RFID System with Nodes 40A-40C communicating over the Wireless Network 50 to one or more Mobile RFID System Servers 10A-10C. The System Servers 10A-10C in turn communicate with their respective Enterprise Systems 30A-30C. FIG. 2 illustrates a scenario with multiple interconnected Mobile RFID System Clients 40A-40C, some of which may be dynamically “occasionally connected” and resident in mobile devices 40A-40C. Others may be statically “always connected” and resident in enterprise servers 30A-30C. The nodes 40A-40C work together to maintain consolidated asset data accessible from the Mobile System Servers 10A-10C.

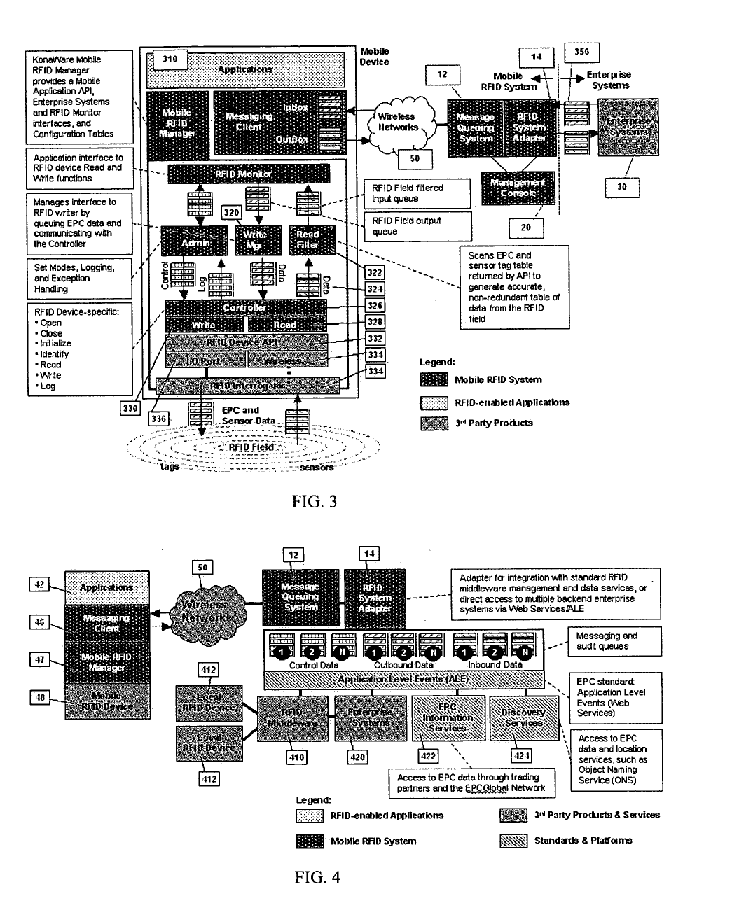

FIG. 3 shows an exemplary block diagram depicting functional components resident on an exemplary mobile computer. Application software resides on an application layer 310. The applications communicate with a mobile RFID manager 312 which provides a mobile application API, enterprise systems and RFID monitor interfaces, and configuration tables. Messaging Client modules 314 communicates with the wireless network 50 through inbox and outbox queues. An RFID monitor 316 supports device read and write functions. An administrative unit 318 enables users to set modes, log data, and handle exceptions. A write manager 320 queues data and communicates with a controller 326, which performs RFID device specific functions such as open, close, initialize, identify, read and write. The controller 326 in turn sends data from sensors through a read filter 322 to the RFID monitor 316. The controller 326 has a write unit 330 and a read unit 328, both of which communicate with an RFID device application programming interface (API) 332. The API 332 in turn communicates with I/O ports 336 and wireless transceivers 334 to an RFID interrogator 338. The tags and sensors can be queried or written to as required.

FIG. 4 shows an exemplary block diagram depicting functional components resident on one or more server computers. As previously discussed, application software 42 interacts with messaging clients 46, mobile RFID manager 47 and mobile RFID device 48 and communicates over the wireless network 50 to the message queuing system 12 and the RFID system adapter 14. The adapter 14 integrates with standard RFID middle ware management and data services, or direct access to multiple back-end enterprise systems. Control data, outbound data and inbound data are transferred over an application level event (ALE) 400 such as Web services. The ALE 400 communicates with an RFID middleware 410, which in turn controls one or more local RFID devices 412 as well as one or more enterprise systems 420. Through the ALE 400, EPC information services 422 and discovery services 424 are also supported. The information services 422 can provide access to EPC data through trading partners and networks. The discovery services

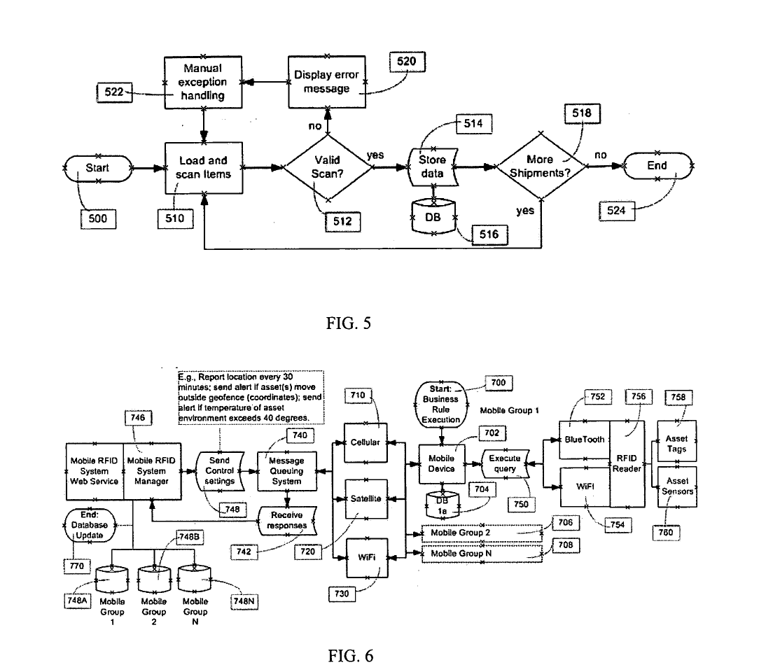

FIG. 5 shows an exemplary flow diagram depicting a process 500 of loading assets into a vehicle or container: First, the process loads and scan items (510). Next, the process checks for a valid scan (512). If valid, the process stores the data (514) in database 516. If not valid, the process 500 displays an error message (520) and provides a manual exception handling operation (522) before looping back to operation 510. From 510, the process checks to see if more shipments exist (518). If an additional shipment exists, the process loops back to operation 510 to continue loading and scanning the next item. If no more shipment exists, the process 500 exits (524).

In process 500, assets are loaded into vehicle or container equipped with the Mobile RFID System. Asset information is automatically scanned using the Mobile Device equipped with RFID. A validation algorithm is applied to each scanned asset to ensure business rules are met (e.g., proper match between assets and intended destination; proper number of assets in the lot). Asset data is stored and associated with a pre-existing record containing ownership, current location, geo-coded destination, geo-fence(s), and any applicable business rules.

FIG. 6 shows an exemplary flow diagram depicting an automatic system and a process for tracking and monitoring assets in the Mobile RFID System 700. The process communicates with a mobile device 702 with a database 704. The mobile device executes queries 750 that can be sent over various channels such as Bluetooth 752 or WiFi 754. The queries and other commands are received by an RFID reader 756 that in turn communicates with asset tags 758 or asset sensors 760. This process can be repeated for a number of mobile groups 706-708. Each mobile group can communicate over a wireless network such as cellular 710, satellite 720, or WiFi 730, among others. The data is received by a message queuing system 740. The queuing system 740 receives responses 742 from a mobile RFID system manager 746 that provides mobile RFID system web services. The mobile RFID system manager 746 in turn sends control settings 748 to the message queuing system 740. The mobile RFID system manager 746 updates and stores data for each mobile group 748A . . . 748N in separate data storage arrays such as databases before exiting the database update operations 770.

In one implementation, Business Rules for Mobile Group(s) (sets, or ‘lots’ of assets) are entered into the Mobile RFID System through a Management Console and stored in the Mobile RFID System Manager. The Mobile Device contacts the Server and requests Business Rules, which are loaded into the Mobile Device. Business Rules include, but are not limited to frequency of reporting, exception handling, and data to be reported. The Business Rules are automatically executed on the Mobile Device to report asset status and location to the Mobile RFID System Manager. In the event that the Mobile Device is temporarily outside of wireless network coverage, the data destined for the Mobile RFID System Manager is queued in the Messaging Client component of the Mobile RFID System Client until network coverage resumes. The Mobile RFID System Manager stores the data in a database that is accessible through the Mobile RFID System Web Service.

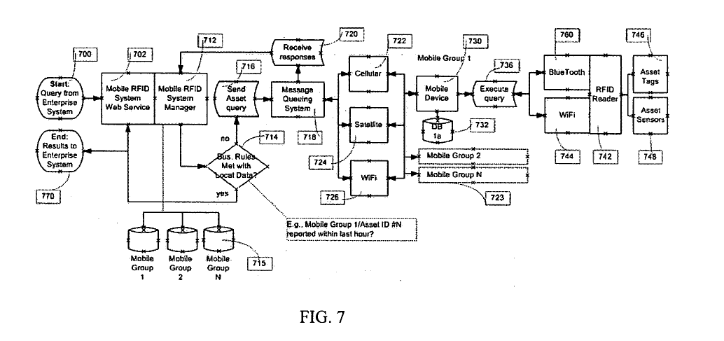

FIG. 7 shows an exemplary flow diagram depicting a system and a process of executing and responding to a query from an Enterprise System. A query 700 is received from an enterprise system and sent to a mobile RFID system web service 702, which communicates the request to a mobile RFID system manager in 712. The system checks if the business rules are met with respect to the local data in 714. If so, data is located from one of mobile group databases 715 and returned as results to the query from the enterprise system in 770. If not, the system sends an asset query in 716 and queues the query in a message queuing system in 718. The system waits for responses to the asset query in 720 and communicates the responses to the mobile RFID system manager in 712. In 718, the message queuing system also communicates over various wireless networks such as cellular (722), satellite (724), or WiFi (726). Data can be transmitted over the wireless networks by one or more mobile groups 723. In one exemplary mobile group 723, data is sent to and from a mobile device 730 with a database 732. The mobile device executes queries 736 that can be sent over various channels such as Bluetooth 740 or WiFi 744. The queries and other commands are received by an RFID reader 742 that in turn communicates with asset tags 746 or asset sensors 748.

In one implementation, a query is received by the Mobile RFID System through the Mobile RFID System Web Service. The Mobile RFID System Manager checks the Business Rules for the asset(s) and performs the appropriate query on the local database and, if necessary, the Mobile RFID System Client nearest to the asset(s). If the requested data is available locally, a response is sent to the Enterprise System. If a request is made to a remote Mobile Device, the device is contacted and responds with the requested data. The Business Rules are automatically executed on the Mobile Device to report asset status and location to the Mobile RFID System Manager. In the event that the Mobile Device is temporarily outside of wireless network coverage, the data destined for the Mobile RFID System Manager is queued in the Messaging Client component of the Mobile RFID System Client until network coverage resumes.

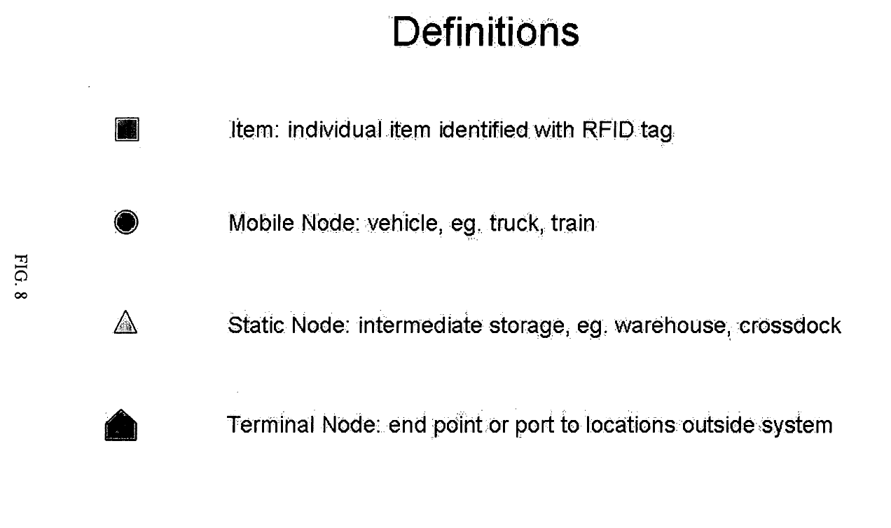

The system consists of items that move from node to node. Supporting this is a set of servers that track the items and nodes. As noted in FIG. 8, an item is an individual entity that is identified with a unique identifier (typically an RFID tag, or barcode). The identifying tag must be readable remotely and automatically so that it can be queried even if there is no human presence. This can be achieved by ensuring that items are placed in locations that have a network of readers that can reach all the items. A mobile node is a vehicle that transports the items, eg. truck, train, ship. It does not require much persistent data storage; only limited storage is needed for caching data; it does not have to store the ID's for all the items (although it can). Item ID readers are mounted on a vehicle, which allow them to dynamically query for the presence of an item. Mobile nodes receive queries from the static node that forwarded the item to locate it using its ID tags. A static node is an intermediate storage place for the items, eg. warehouse, crossdock, distribution center. It stores information about all items currently in its location or being forwarded to another location (but not reached the destination yet). The information is stored on a computer system with sufficient disk storage for all items currently located at its premises. The computer system interfaces with readers that can reach all items. The computer system must be attached to a network that reaches its server. A terminal node is an end point or port to locations outside the system, eg. a factory, shipping port, airport. The information is stored on a computer system with sufficient disk storage for all items currently located at its premises. The computer system interfaces with readers that can reach all items. The computer system must be attached to a network that reaches its server. For static and terminal nodes, the information about items can alternatively be stored on the servers instead of its own computers.

Security is an important aspect of this system because of the nature of supply chains. Various partners in intersecting supply chains might have adversarial relationships and do not want information shared with opposing partners. For instance, two suppliers A and B might use the same carrier (e.g., UPS logistics) to take care of their shipping needs. They do not want each other to view where their items are in the shipping process as this information might provide invaluable competitive information (e.g., destinations, quantities). It is therefore important to protect the privacy of the information. The two aspects of security addressed in this system are authentication and authorization. Authentication is enforced between the servers and nodes. A node has to log into its assigned server each time it connects. This can be done using the usual methods of authentication, for example an account ID and password. Data encryption can be implemented using standard techniques such as public-key encryption and X509 digital certificates, for example. Because the system is automatically tracks the location of items, it cannot require a user to manually authorize every transaction. Instead, the system makes an implicit assumption that the origin static/terminal node is authorized to query the location of an item that is sent to a destination static/terminal node, since obviously it had to know where the item was going. For example, if an item was sent from node A to B and then to C, node A is authorized to query the location of that item between A and B (including all the mobile nodes used in between the nodes). Node B is then authorized to query for the item when it travels between B and C. Therefore, node A can query node C and any subsequent node. This is called authorization forward chaining and can be done automatically. A node can override this by breaking the chain at its location although this is not recommended as the visibility of an item's location is curtailed at that node. To overcome objections for sharing the information, the system defaults the information to only the location coordinates (latitude, longitude) of the item and the arrival date and timestamp. It does not give away the identity of the node, which might be considered confidential, for instance if a third-party logistics (3PL) provider does not want its customers to know which carriers it uses to transport the items.

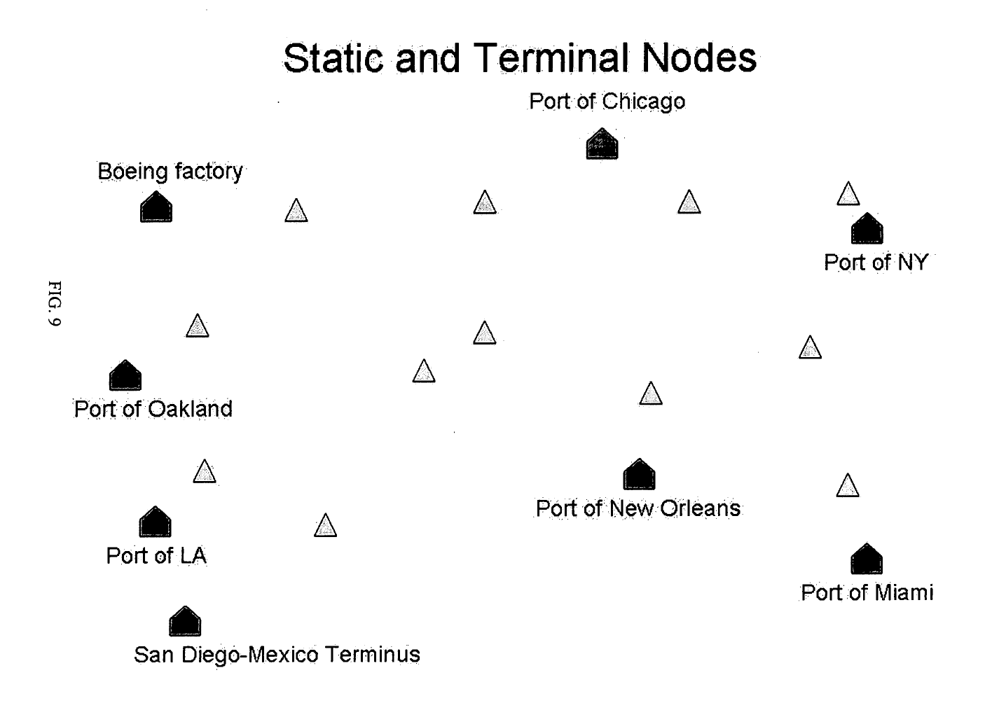

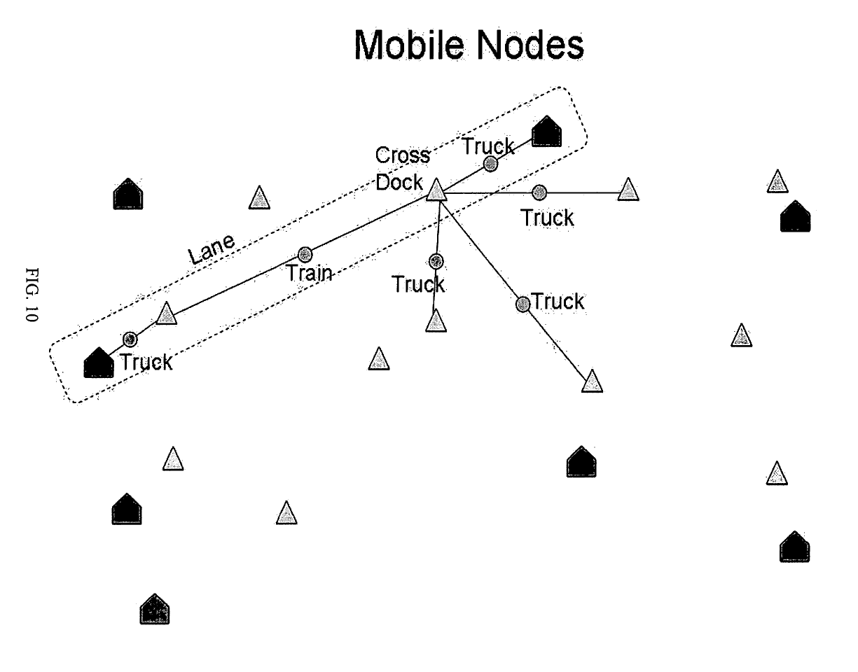

Turning now to the figures, FIG. 8 shows the symbols used to indicate the components of the system. FIG. 9 illustrates how a combination of static and terminal nodes is used in the system. FIG. 10 illustrates how mobile nodes fit into the system. FIG. 8 shows symbols used to indicate the components of the system in FIGS. 9-20. A Square indicates an individual item to be tracked with an ID tag (eg. RFID, barcode). A Circle indicates a mobile node, ie. one that can move, like a truck, van, train, ship. A Triangle indicates a static node where an item is stored, eg. warehouse, crossdock, distribution center. A Pentagon (house shape) indicates a terminal node where an item originates or is consumed in the system.

FIG. 9 shows an exemplary system with Static and Terminal Nodes. In this example, the static nodes include a San Diego port terminal node, a Los Angeles port terminal node, an Oakland terminal node, and a Boeing factory terminal node. In FIG. 9, the terminal nodes are at shipping ports where items are shipped in and out of the system. Further, the Boeing terminal node consumes items to be made into other products (which then become new items). FIG. 9 also shows various static nodes around the country through which items are shipped.

FIG. 10 shows examples of Mobile Nodes. This diagram illustrates examples of mobile nodes in the system. A set of static and mobile nodes that constitute a regular route through which an item travels is called a lane. The lane may include truck, trains, ships, or airplanes that provide transportation paths.

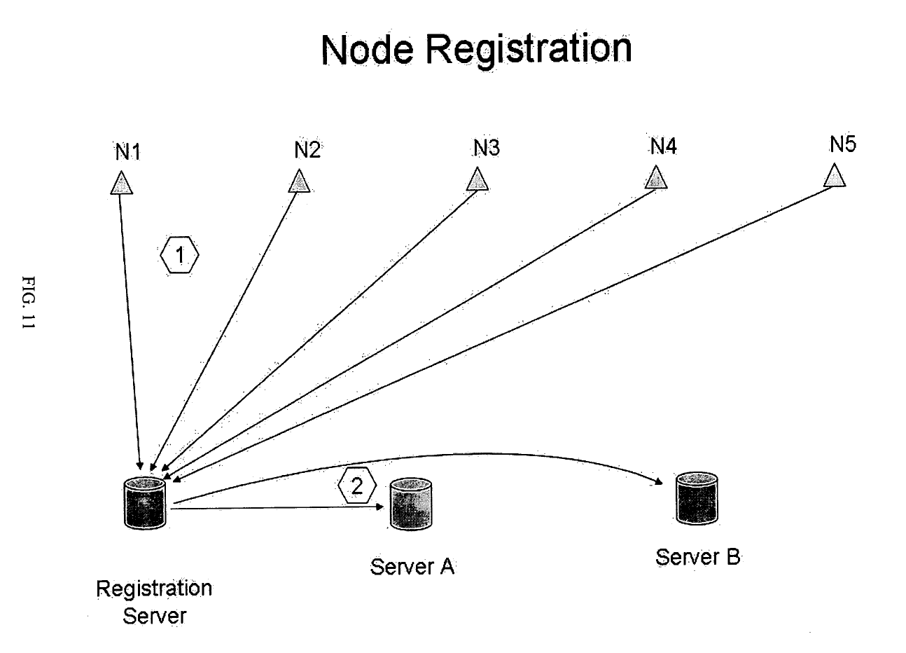

FIG. 11 shows an exemplary process for Node Registration. This diagram illustrates the process by which new nodes are registered with the system. The system includes one or more registration servers and one or more communication servers (or home servers) that talk to each node. When viewed with FIG. 11, the registration process is as follows:
Step 1: When a static or terminal node is brought on line, it first registers itself to the registration server. The registration process creates a unique account ID and password for the node. The registration server then assigns the new node to its home server to which is must now connect for any transactions. The registration server returns the location of the home server to the node.
Step 2: The registration server transfers the credentials (account ID, password) to the home server so that when the node connects to the home server, it is able to log in.

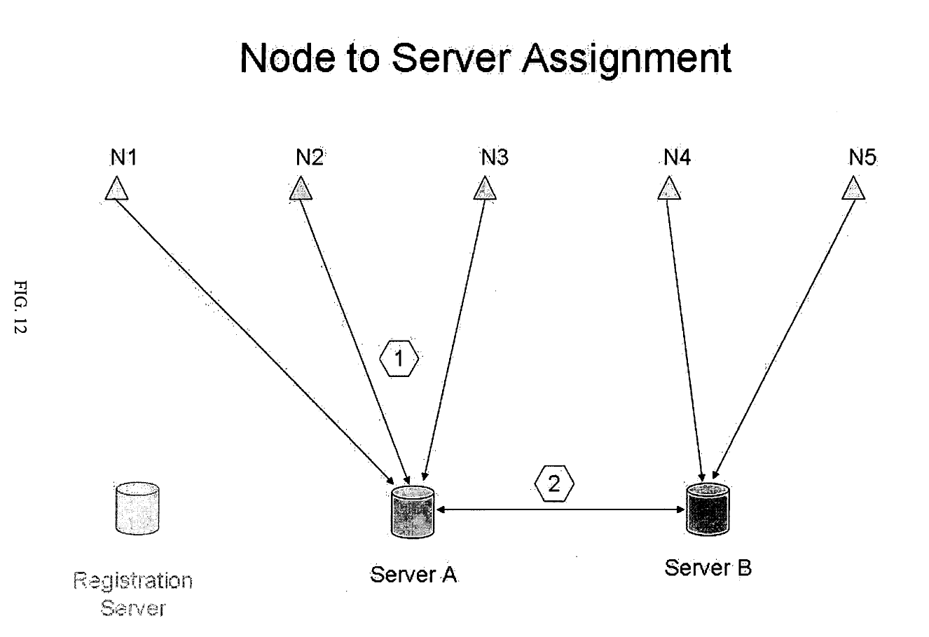

FIG. 12 shows an exemplary process to perform Node to Server Assignment. This diagram illustrates the assignments between nodes and servers. A node is assigned to only one server and must communicate with other nodes through its server. When a node has been registered, it then needs to connect to its home server. FIG. 12 illustrates this exemplary system:
Step 1: Nodes N1, N2, N3 are assigned to server A and will only communicate with Server A. They each login with their respective account ID's and passwords to server A. Nodes N4, N5 are assigned to Server B and will only communicate with server B. They each login with their respective account ID's and passwords to server B. If node N4 tries to log into server A, it will not be authenticated. However, if a node wishes to make a query, this is sent to the registration server instead of the home server because the registration server keeps the list of all the home servers to which it will broadcast the query. This will allow new home servers to be added at any time.
Step 2: Any communication between nodes on different home servers goes through the home servers. For example, if node N2 wants to talk to node N5, it first talks to server A, which transmits the transaction to server B, which then forwards it to node N5. Even if a node is talking to a node connected to its home server, it must always go through the home server. For instance, if node N1 wants to talk to node N2, then it must send the transaction via server A. This procedure is done since nodes might be reassigned over time to balance transaction loads and therefore hard links between nodes are not established to provide this flexibility.

All nodes (mobile, static, terminal) are registered in the same manner. A node can be unregistered by connecting to the registration server and sending a request to terminate its account. Once this is done, it cannot connect to its home server anymore. In order to reestablish itself in the system, the node must register again as a new node.

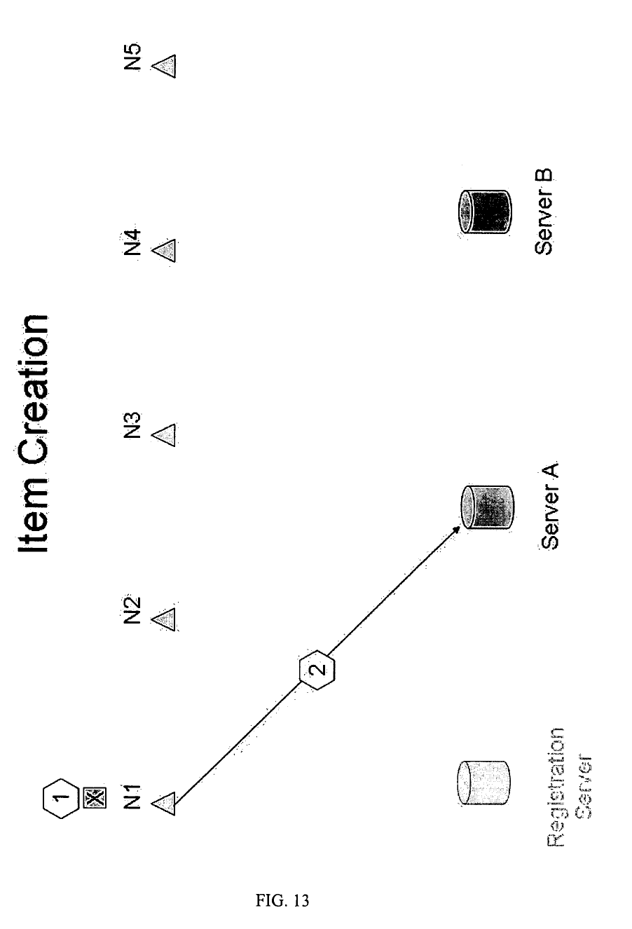

FIG. 13 shows an exemplary process for Item Creation. This diagram illustrates how an item entering the system is created on the node through which it first appears. An item can appear anywhere in the system. It must be associated with a node where it originated. This can be a static, terminal or mobile node. Typically, an item appears in a system at the factory where the item is manufactured, which is a terminal node. However, some factories are not part of the system, so the item is created at a mobile node on which the item is shipped, or a static node (like a logistic company's warehouse).
Step 1: Item X is appears at node N1. A new record for the item is created at node N1.
Step 2: N1 informs its home server A of the creation of item X. Server A creates a new record for item X
   In one implementation, the item record on the node consists of the following:
Item ID (primary key)
Arrival date and time
Departure date and time
Mobile node ID to which the item has been forwarded
Shipment ID: this is a unique ID that is automatically generated for all items that have been forwarded to a mobile node.
Last known position: this is returned from a ping of the mobile node onto which the item was loaded
Status: On site|Transit|Consumed|Missing (other status fields can be added later)
Attachments. The node can add other data fields it wishes to associate with this item. For example, if it wants to track the current temperature or barometric pressure reading, this can be added here.
   In an implementation, the item record on server consists of the following:
Item ID (primary key)
Current location: Node account ID
Current location: GPS LAT/LONG
Authorization List: (FIFO order) eg. N1, N2, N3, N4, N5
Arrival date/time at location
Status: On site|Transit|Consumed|Missing (other fields can be added later)
Attachments

The records created on the nodes and servers are similar. For this reason, nodes that do not have a large data storage capacity can delegate the responsibility for storing the information about each item on its home server by adding the additional fields. This will increase the number of transactions because the home server will now receive positional updates for the item, which used to get stored only on the node.

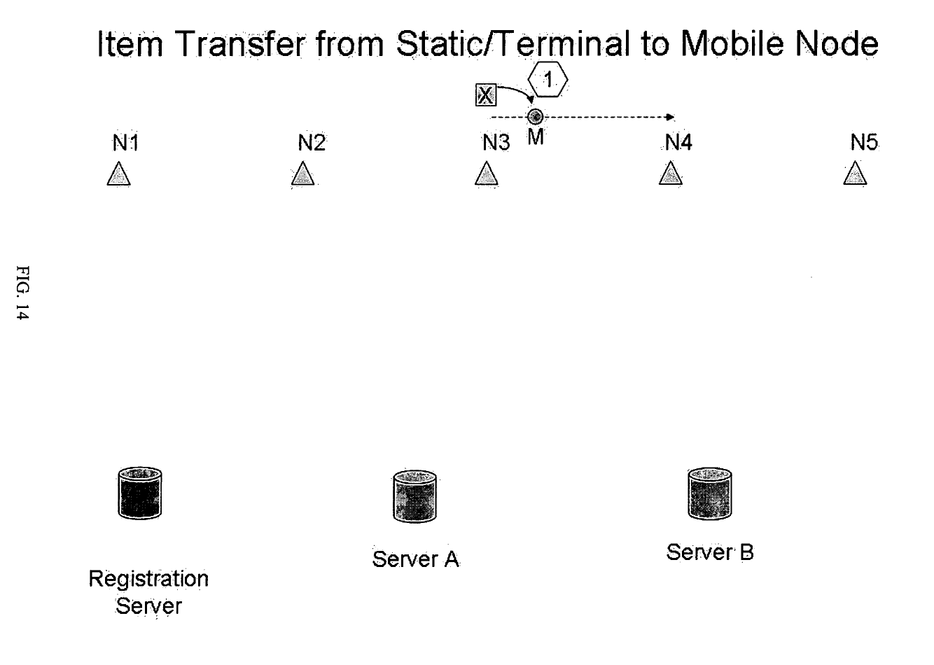

FIG. 14 shows an exemplary process for performing Item Transfer from Static/Terminal to Mobile Node. This diagram illustrates how an item is transferred from one a static or terminal node to a mobile node. FIG. 14 illustrates an exemplary process for an item transfer from a static/terminal to a mobile node.
Step 1:
   Item X is loaded onto mobile node M (eg. truck, train)
   Item X's record on node N3 is updated to reflect that item X has been loaded onto mobile node M

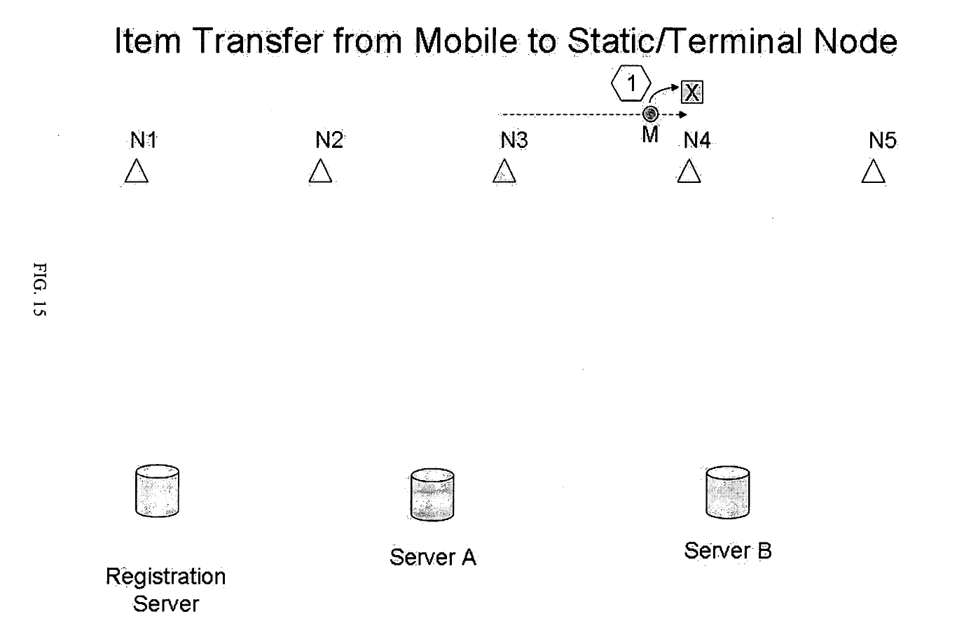

FIG. 15 shows an exemplary process for performing Item Transfer from Mobile to Static/Terminal Node. This diagram illustrates how an item is transferred off a mobile node to a static or terminal node. FIG. 15 illustrates the process for an item transfer from a mobile to a static/terminal node.
Step 1: Item X is unloaded from mobile node M to static node N4 (which could also be a terminal node)
Step 2: Node N4 checks for record of item X. If it is found (eg. damaged item returned to warehouse), then it updates its record that item X is in its location. If record of item X is not found, then it must talk to its server to have the record transferred over. See scenario “Item Record Transfer”.

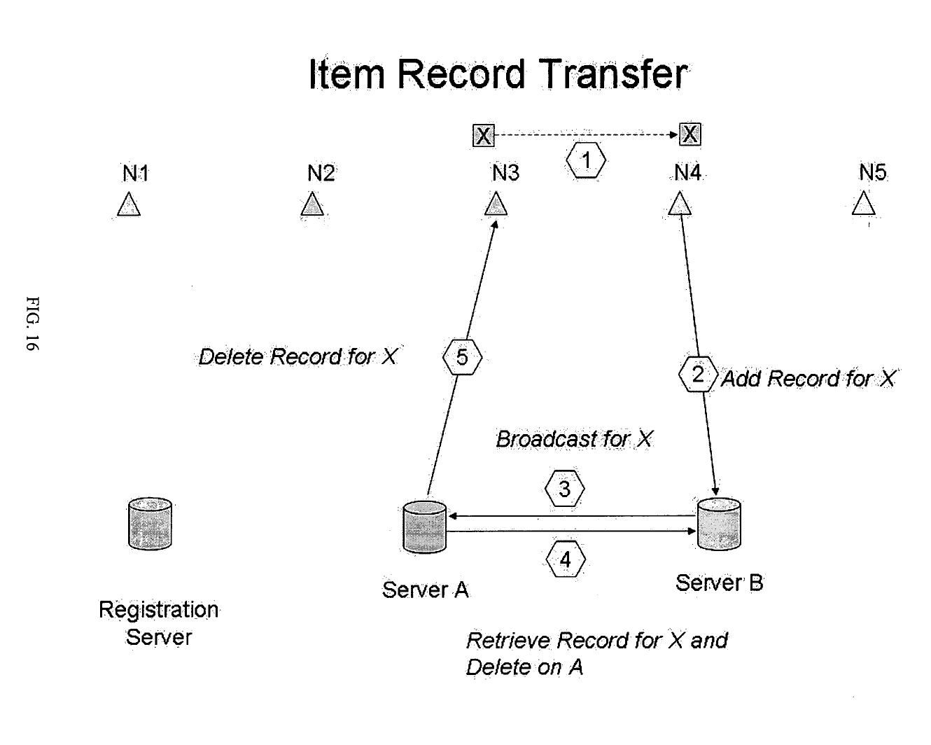

FIG. 16 shows an exemplary process for performing Item Record Transfer. This diagram illustrates what happens when an item has successfully moved from one static/terminal node to another static/terminal node and the transfer of that item's record from one server to another. In the process for transferring an item record between servers, an item record is stored in the home server associated with the node where the item is physically located. If that item has been moved to another node that belongs to a different home server, then the item record is transferred to the new home server.
Step 1: Item X is transferred from node N3 to node N4
Step 2:
   Item X is recorded at N4 with a date and time stamp
   N4 sends to its server B:
      a. Item ID tag information for X
      b. Arrival date and time
      c. GPS location for N4
Step 3:
   Server B:
      Does not find record of item X
      Sends a broadcast to other servers
Step 4:
   Server A returns record of item X
   Server B creates new record for item X and adds N4 to authorization list behind N3
   Server A deletes record for item X after receiving acknowledgement from server B that it has been recorded (transaction semantics)
Step 5:
   Server A notifies node N3 that item X has been transferred
   Node N3 deletes record of item X from its database

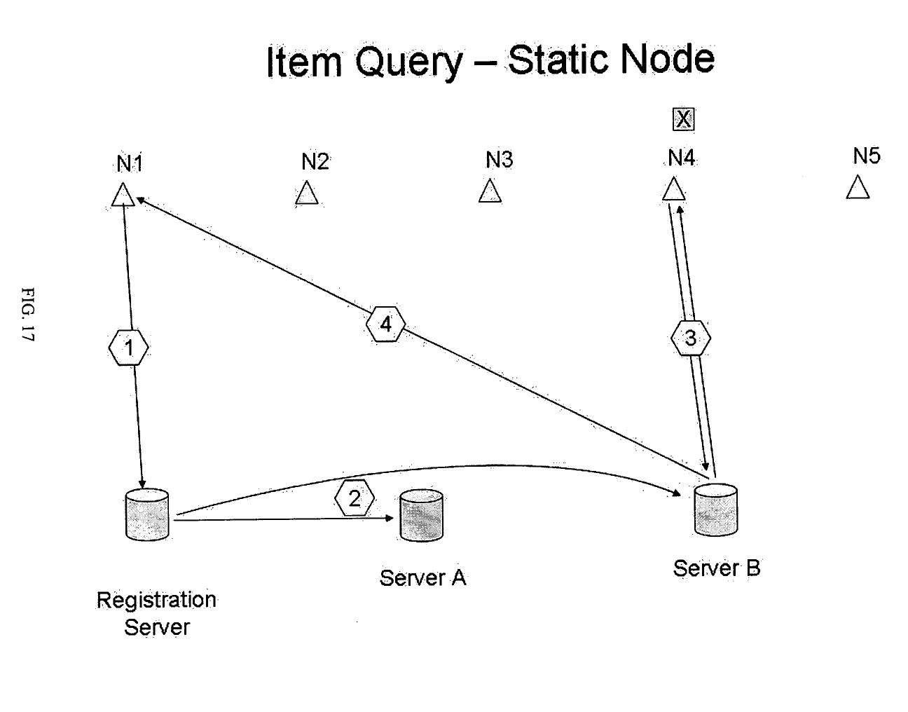

FIG. 17 shows an exemplary process for performing Item Query to Static Node. This diagram illustrates the process for querying the location of an item located at a static or terminal node. During this process, an item query should come from a static or terminal node and not a mobile node because only these are stored on the authorization list of the item record.
Step 1:
   Node N1 makes a query of location of item X to registration server.
   The reason that it sends the query to the registration server
Step 2:
   Registration Server broadcasts query to all servers
Step 3:
   Server B has the record of item X and checks for authorization of node N1 to get location information. Assuming that item X was originally sent from N1, then the record will have N1 and therefore authorization will be granted.
   Server B then queries N4 where the item X was last located and receives a response from N4 that item X is still at its location
Step 4:
   Server B sends a message to N1 with the GPS location and arrival date/time of Item X

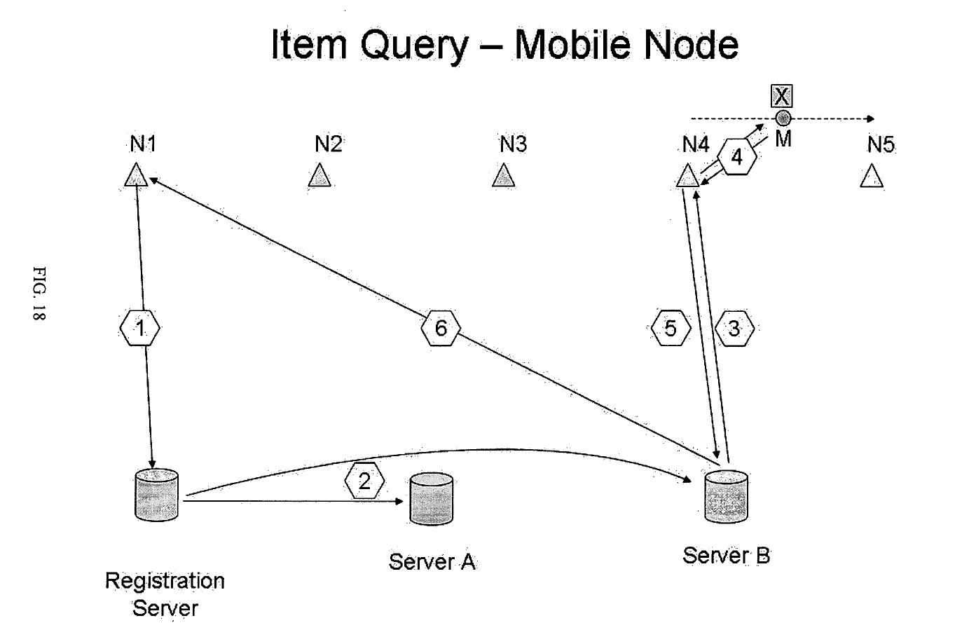

FIG. 18 shows an exemplary process for performing Item Query to Mobile Node. This diagram illustrates the process for querying the location of an item located in a mobile node. During the processing of the item query to a mobile node, an item query must come from a static or terminal node. Note that the node does not need to know that an item is on a mobile node, it simply invokes a query for an item given the item's unique ID.
Step 1:
   Node N1 makes a query of location of item X to registration server
Step 2:
   Registration server broadcasts query to all servers
Step 3:
   Server B has the record for item X and checks for authorization of node N1 to get location information. Assuming that item X was originally sent from N1, then the record will have N1 and therefore authorization will be granted.
   Server B then queries N4 where the item X was last located
Step 4:
   Node N4 checks its records and realizes that item X has been forwarded on mobile node M, so it sends the query to M.
   Mobile node M receives the query and checks authorization. Only the last static node that forwarded the item is allowed to check status. M verifies that node N4 was the last static node and queries for Item X.
   Item X is found on mobile node M, so mobile node M replies to static node N4 that item X has been found with current location and date/time.
Step 5:
   Node N4 replies to server B with location information of item X
Step 6:
   Server B sends a message to node N1 with location information of item X

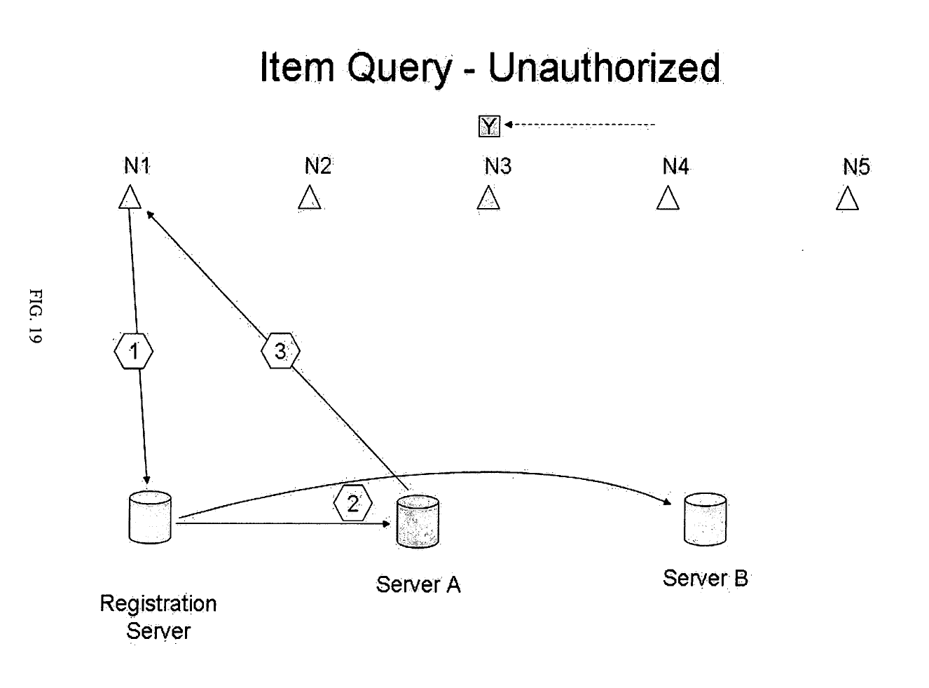

FIG. 19 shows an exemplary process for performing Unauthorized Item Query. This diagram illustrates the process when an unauthorized query is made for the location of an item as the system cannot assume that all queries for items are authorized. In the example of an unauthorized item query, assume item Y was delivered to node N3 from node N4, and did not go through N1 or N2. Therefore, according to our authorization forward chaining rule explained earlier, node N1 is not authorized to query about the location of item Y.
Step 1:
   Node N1 makes a query for the location of item Y
   The query is sent to the Registration Server
Step 2:
   The Registration Server sends the query to all the servers
Step 3:
   Server A finds a record for item Y and checks if node N1 is on the list of nodes that item Y has passed through. Since it has not, server A replies to node N1 that it is not authorized to get the information.

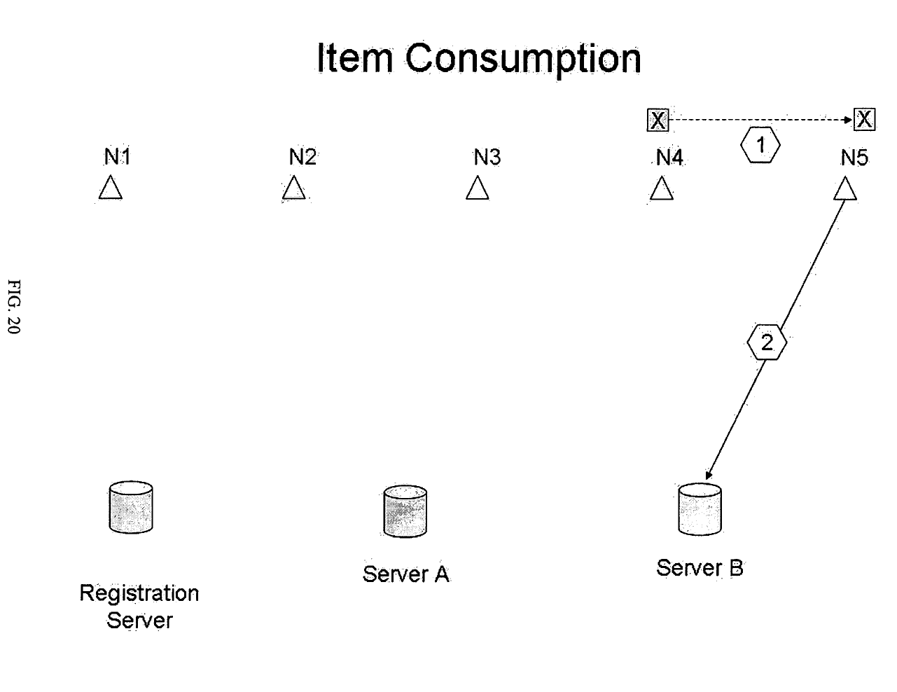

FIG. 20 shows an exemplary process for performing Item Consumption. This diagram illustrates the process when an item is transferred to a terminal node. When an item is delivered to a terminal node and is moved out of the system where it cannot be tracked any further, it must be marked accordingly so that queries can be properly returned. The process to handle the item consumption scenario is as follows:
Step 1:
   Item X is consumed at node N5
   Eg. Item X is a part that is used to manufacture a product
   N5 records arrival for item X
Step 2:
   Node N5 sends information to server B
      Action=CONSUMED
      Date/Time of arrival
   Server B
      Marks Item as consumed at N5
      Keeps record for a while before deleting. This should be configurable

This system continuously tracks the locations of all items by sending a ping from the origin node to the mobile node. Since most shipments consist of many items, sometimes numbering in the thousands or even millions, it is inefficient to monitor every single item's location. When an item is loaded onto a mobile node, it is assigned a shipment ID, which is a unique ID that is automatically generated by the origin node. The system first checks for other shipments on the same mobile node on the same date and within a similar window of time. If so, it assumes that the item is on the same shipment and assigns it the same previously generated shipment ID. A static node constantly checks item location by running through its set of active shipment ID's and pings the mobile node to check for an item's location. A mobile node returns with its current location and whether the item is still there as well as the current location coordinates. If not, it will return the destination nodes' ID. A ping should query for random item ID's on the mobile node to ensure the integrity of the shipment because items might be removed off the mobile node. If a mobile node is out of coverage, multiple pings might be queued up on the static node and sent when the mobile node is back in coverage. Multiple pings are discarded and only one response is sent back. This offers an optimal method for tracking all the items without unnecessary queries.

Exception Management is built into the system in the following cases:

Item ID tag failure
Item ID tag reader failure
Item ID tag obscured from reader
Item ID routed to location with no reader
Pilferage
Damage

The static node forwards an item retains that item's record until it has been positively acknowledged by the destination node. This is similar to a transaction semantic that requires an acknowledgement before committing that transaction. In the case where any of the exceptions listed above occurs, then the item record remains open. By continuously monitoring the location of an item, the system will know if there is a problem and can therefore trigger an exception management action, such as sending an alert to the administrator at the originating node to investigate the discrepancy.

An alert can be sent if the destination node did not report an item's expected arrival. If an item is loaded off a mobile node into a static node, then the static node should create a record for the item and update the server, which will inform the origin node. Since the origin node is constantly pinging the mobile node, if the mobile node indicates that the item has been offloaded but the destination node has not reported its arrival, then an alert should be sent to the origin and destination nodes informing them of the discrepancy. The origin node then sends a query to the server which will broadcast it to all static nodes. If any node has received the item, then the records on the origin and destination nodes are reconciled automatically. If not, then the origin node will list the item as missing. Note that because the system does not know the destination node of an item a priori, it cannot query the destination node with regards to the location of that item. It can only wait until the pings to the item have failed after several successive attempts.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method to track first and second nodes equipped with radio frequency identification (RFID) tag readers, comprising:
registering a first node and a second node with a registration server;
assigning the first and second nodes to first and second home servers respectively, wherein the first node is authorized to communicate with the first home server and the second node is authorized to communicate with the second home server; and
for each query requested by each node, sending the query to the registration server to be broadcasted to the home servers.

2. The method of claim 1, comprising communicating data between the first and second nodes.

3. The method of claim 2, comprising sending data from the first node to the first home server, sending data from the first to the second home server, and sending data from the second home server to the second node.

4. The method of claim 1, comprising authenticating each node.

5. The method of claim 4, wherein authenticating further comprises submitting an identification and a password.

6. The method of claim 1, wherein each node comprises one of: a static node, a terminal node, a mobile node.

7. The method of claim 1, comprising communicating node data over multiple, disparate, and intermittently connected wireless networks.

8. The method of claim 1, comprising determining a physical location or an environmental status of a node.

9. The method of claim 1, comprising monitoring of assets including one of: a vehicle, a container, an equipment, and inventory.

10. The method of claim 1, comprising performing a bi-directional transmission of requests from, and replies to, applications containing commands, and status and location data.

11. The method of claim 1, comprising performing authorization forward chaining.

12. The method of claim 1, comprising communicating only node location and date information.

13. A system to track first and second wireless nodes, comprising:
a network;
first and second home servers coupled to the network and communicating with the first and second wireless nodes, respectively, wherein the first node is authorized to communicate with the first home server and the second node is authorized to communicate with the second home server;
a registration server coupled to the network and adapted to assign the first node to the first home server and the second node to the second home server; and
an enterprise computer coupled to the network to query the nodes.

14. The system of claim 13, comprising:
a mobile computer coupled to one of the home servers;
a radio frequency identification (RFID) reader; and
a plurality of assets equipped with RFID tags.

15. The system of claim 13, comprising a Web Service for programmatic access to the nodes.

16. The system of claim 13, comprising a system manager function for single point of access to myriad interconnected fixed and mobile RFID nodes.

17. The system of claim 13, comprising a multi-channel wireless platform for guaranteed communications.

18. The system of claim 17, wherein multi-channel wireless platform comprises one of: a cellular radio, a satellite radio, a WiFi radio.

19. The system of claim 13, wherein the network is secure.

20. The system of claim 13, wherein the home server enforces authentication and authorization of each node.
